(19) United States
(12) Patent Application Publication
(10) Pub. No.: US 2023/0061674 A1
(43) Pub. Date: Mar. 2, 2023

(54) NON-PNEUMATIC TIRE WITH IMPROVED SHEAR BAND

(71) Applicant: The Goodyear Tire & Rubber Company, Akron, OH (US)

(72) Inventors: Andrew James Miller, Berlin Center, OH (US); Ann Elizabeth Myers, Cuyahoga Falls, OH (US)

(21) Appl. No.: 17/811,924

(22) Filed: Jul. 12, 2022

Related U.S. Application Data
(60) Provisional application No. 63/260,810, filed on Sep. 1, 2021.

(51) Int. Cl. B60C 7/10; B60C 7/14

(52) U.S. Cl. CPC B60C 7/102; B60C 7/146

(57) ABSTRACT

A non-pneumatic tire includes a tread; a shear band, and a connecting web positioned between a hub and the shear band. The shear band has a first and second membrane layer formed of a plurality of parallel reinforcement cords arranged at an angle of 10 degrees or less with respect to the tire equatorial plane, said o tread further comprises a first angled belt located radially outward of the second membrane layer, and a second angled belt located radially outward of the first angled belt, wherein the first and second angled belt each have parallel reinforcement cords having a belt angle in the range of 15-30 degrees with respect to the tire equatorial plane, and wherein the angle of the second angled belt has an angle equal and opposite direction of the belt angle of the first angled belt.

### FIELD OF THE INVENTION

The present invention relates generally to vehicle tires and non-pneumatic tires, and more particularly, to a shear band and non-pneumatic tire.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominant today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed gasses. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

The purpose of the shear band is to transfer the load from contact with the ground through tension in the spokes or connecting web to the hub, creating a top loading structure. When the shear band deforms, its preferred form of deformation is shear over bending. The shear mode of deformation occurs because of the inextensible membranes located on the outer portions of the shear band.

Prior art non-pneumatic tires typically have a shear band made from rubber materials sandwiched between at least two layers of inextensible belts or membranes. The disadvantage to this type of construction is that the ride and handling of the vehicle may suffer due to the large amount of rubber in the shearband. In addition, the rolling resistance may also suffer due to the large amount of rubber. Thus, an improved shearband for a non-pneumatic tire is desired that has improved vehicle handling and rolling resistance.

### BRIEF DESCRIPTION OF THE DRAWINGS

The present invention will be better understood through reference to the following description and the appended drawings, in which:

FIG. 1 is a perspective view of a first embodiment of a non-pneumatic tire of the present invention; and

FIG. 2 is a cross-sectional view of a first embodiment of a shear band of the present invention.

### DEFINITIONS

The following terms are defined as follows for this description.

“Equatorial Plane” means a plane perpendicular to the axis of rotation of the tire passing through the centerline of the tire.

“Inextensible” means that a given layer has an extensional stiffness greater than about 25 Ksi.

### DETAILED DESCRIPTION OF THE INVENTION

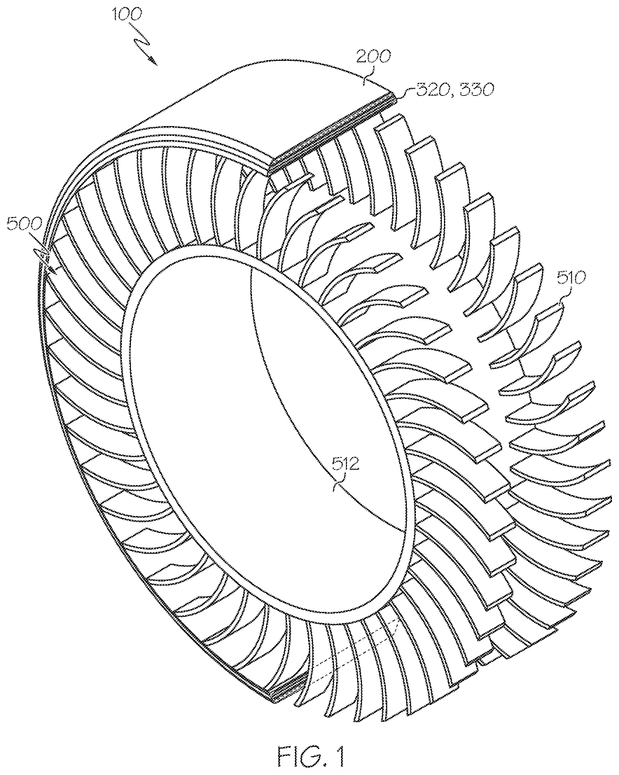

A first embodiment of a non-pneumatic tire 100 of the present invention is shown in FIG. 1. The tire of the present invention includes a radially outer ground engaging tread 200, a shear band 300, and a connecting web 500. The tire tread 200 may include elements such as ribs, blocks, lugs, grooves 210, and sipes as desired to improve the performance of the tire in various conditions. The connecting web 500 is mounted on hub 512 and may have different designs, as described in more detail, below. The non-pneumatic tire of the present invention is designed to be a top loading structure, so that the shear band 300 and the connecting web 500 efficiently carry the load. The connecting web is designed to be a stiff structure when in tension that buckles or deforms in the tire footprint and does not compress or carry a compressive load. This allows the rest of the connecting web not in the footprint area the ability to carry the load, resulting in a very load efficient structure. It is desired to allow the shearband to bend to overcome road obstacles. The approximate load distribution is preferably such that approximately 90-100% of the load is carried by the shear band and the upper portion of the connecting web, so that the lower portion of the connecting web carry virtually zero of the load, and preferably less than 10%.

### Shear Band

The shear band 300 is preferably an annular structure that is located radially inward of the tire tread 200 and functions to transfer the load from the bottom of the tire which is in contact with the ground to the spokes and to the hub, creating a top loading structure. The annular structure 300 is called a shear band because the preferred form of deformation is shear over bending.

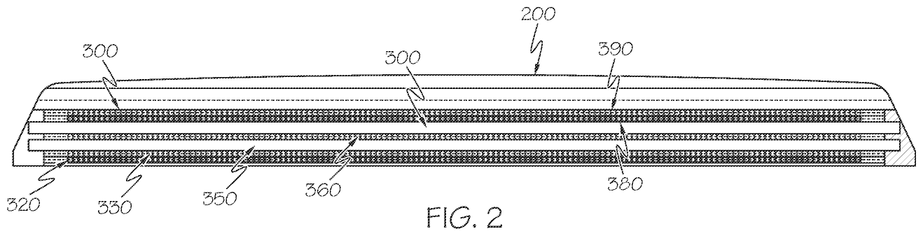

A first embodiment of a shear band 300 is shown in FIG. 2. The shear band may include a first, second and third reinforcement layer 320, 330, 360. Each reinforcement layer is formed of a plurality of closely spaced parallel reinforcement cords. The parallel reinforcement cords may be formed from a calendared fabric so that the reinforcement cords are embedded in an elastomeric coating. Preferably, each reinforcement layer 320, 330, 360 is formed from spirally winding a single end cord. Preferably, the single end cord has multiple filaments.

The first and second reinforcement layers 320, 330 are preferably the radially innermost reinforcement layers of the shear band 300, and the second reinforcement layer 330 is located radially outward of the first membrane layer. The third reinforcement layer 360 is located radially outward of the second reinforcement layer 330. The inextensible reinforcement cords of each layer 320, 330, 360 are preferably angled in the range of five degrees or less with respect to the tire equatorial plane. The reinforcing cords of the first and second reinforcement layers 320, 330 may be suitable tire belt reinforcements, such as monofilaments or cords of steel, aramid, and/or other high modulus textiles. For example, the reinforcing cords may be steel cords of four wires of 0.28 mm diameter (4×0.28) or 0.22 mm diameter. In another example, the reinforcing cords may be steel cords of 6 wires, with five wires surrounding a central wire (5+1) construction.

The third reinforcement layer 360 is separated from the second reinforcement layer 330 by a first shear layer 350. The shear band 300 further comprises a second shear layer 370 located radially outward of the third reinforcement layer 360. The first and second shear layer 350, 370 is formed of an elastomer or rubber having a shear modulus in the range of 3 MPa to 30 MPa, or more preferably in the range of 10 MPa to 20 MPa.

The shear modulus is defined using a pure shear deformation test, recording the stress and strain, and determining the slope of the resulting stress-strain curve.

The shear band 300 further includes a first angled belt 380 and a second angled belt 390. The first angled belt 380 is located radially outward of the second shear layer 370, and the second angled belt 390 is located radially outward of the first angled belt 380. The first and second angled belts 380, 390 each have parallel reinforcement cords that are embedded in an elastomeric coating. The parallel reinforcement cords are preferably angled in the range of 15 to 30 degrees with respect to the tire equatorial plane. Preferably, the angle of the parallel reinforcement cords is in the range of 20-25 degrees. Preferably, the angle of the reinforcement cords of the first angled belt is in the opposite direction of the angle of the reinforcement cords in the second angled belt. It is additionally preferred that the reinforcement cords are inextensible.

### Shear Band Properties

The shear band has an overall shear stiffness GA. The shear stiffness GA may be determined by measuring the deflection on a representative test specimen taken from the shear band. The upper surface of the test specimen is subjected to a lateral shear force F. The test specimen is a representative sample taken from the shear band and having the same radial thickness as the shearband. The shear stiffness GA is then calculated from the following equation:

GA=F*L/ΔX, where F is the shear load, L is the shear layer thickness, and delta X is the shear deflection. It is preferred that GA be I the range of about 15,000 N to 35,000 N, and more preferably, about 25,000 N.

The shear band has an overall bending stiffness EI. The bending stiffness EI may be determined from beam mechanics using the three point bending test. It represents the case of a beam resting on two roller supports and subjected to a concentrated load applied in the middle of the beam. The bending stiffness EI is determined from the following equation: EI=PL3/48*ΔX, where P is the load, L is the beam length, and ΔX is the deflection. It is preferred that EI be about equal to 220 E6 N-mm².

It is desirable to maximize the bending stiffness of the shearband EI and minimize the shear band stiffness GA. The acceptable ratio of GA/EI would be between 0.01 and 20, with an ideal range between 0.01 and 5. EA is the extensible stiffness of the shear band, and it is determined experimentally by applying a tensile force and measuring the change in length. The ratio of the EA to EI of the shearband is acceptable in the range of 1000 to 3000, and more preferably in the range of 1500-3000.

### Connecting Web

The non-pneumatic tire of the present invention further includes a connecting web 500 as shown in FIG. 1. The connecting web preferably comprises a plurality of circumferentially aligned spokes 510 that extend from an inner radius to an outer radius. The spokes are preferably oriented in the radial direction. The spokes may be curved or straight. Preferably, the non-pneumatic tire comprises two sets of circumferentially aligned spokes. The spokes may have different cross-sectional designs. The spokes functions to carry the load transmitted from the shear layer. The spokes are primarily loaded in tension and shear, and carry no load in compression. Each spoke as described herein preferably has an axial thickness A that is substantially less than the axial thickness AW of the non-pneumatic tire. The axial thickness A is in the range of 5-20% of AW, more preferably 5-10% AW.

The spokes are preferably formed of an elastic material such as rubber or a thermoplastic elastomer. The spokes are designed such that the spokes have a low resistance to radial deformation and a higher resistance to the lateral deformation of the tire.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A nonpneumatic tire comprising:
an outer annular tread, a plurality of connecting structures connecting the tread band to a hub,
wherein said outer annular tread further comprises a first reinforcement layer located radially inward of the outer annular tread,
a second reinforcement layer located radially outward of the first reinforcement layer, wherein the first and second reinforcement layers are formed of a plurality of parallel reinforcement cords arranged at an angle of 10 degrees or less with respect to the tire equatorial plane,
said outer annular tread further comprises a first angled belt located radially outward of the second reinforcement layer, and a second angled belt located radially outward of the first angled belt, wherein the first and second angled belt each have parallel reinforcement cords having a belt angle in the range of 15-30 degrees with respect to the tire equatorial plane, and wherein the angle of the second angled belt has an angle equal and opposite direction of the belt angle of the first angled belt.

2. The nonpneumatic tire of claim 1 wherein the first and second reinforcement layer are formed of said reinforcement cords arranged at an angle of zero degrees with respect to the tire equatorial plane.

3. The nonpneumatic tire of claim 1 further including a third membrane layer formed of said reinforcement cords arranged at an angle of zero degrees with respect to the tire equatorial plane.

4. The nonpneumatic tire of claim 3 further including a first shear layer located between the second membrane layer and the third membrane layer.

5. The nonpneumatic tire of claim 3 further including a second shear layer located between the third membrane layer and the first angled belt.

6. The nonpneumatic tire of claim 1 wherein the parallel reinforcement cords are made of steel.
